(19) United States
(12) Patent Application Publication
(10) Pub. No.: US 2026/0081083 A1
(43) Pub. Date: Mar. 19, 2026

(54) KEYCAP LIFTING MECHANISM AND LONG RECTANGULAR KEYSWITCH STRUCTURE

(71) Applicant: Darfon Electronics Corp., Taoyuan City (TW)

(72) Inventors: Ming-Yuan Hsieh, Taoyuan City (TW); Po-Wei Tsai, Taoyuan City (TW)

(73) Assignee: Darfon Electronics Corp., Taoyuan City (TW)

(21) Appl. No.: 19/329,563

(22) Filed: Sep. 16, 2025

Related U.S. Application Data
(60) Provisional application No. 63/696,374, filed on Sep. 18, 2024.

(30) Foreign Application Priority Data
Sep. 9, 2025 (TW) 114134496

(51) Int. Cl. H01H 13/52; H01H 13/04; H01H 13/10; H01H 13/14

(52) U.S. Cl. CPC H01H 13/52; H01H 13/04; H01H 13/10; H01H 13/14

(57) ABSTRACT

A keycap lifting mechanism includes a first support and a second support. Each of the first support and the second support includes a long arm and a plurality of support arms protruding from the long arm. The first support and the second support are pivotally connected with each other around a pivot axis through the support arms of the first support and the second support that are staggered along the pivot axis, and jointly form two support structures and an intermediate support structure between them. Two of the support arms on two opposite sides of the intermediate support structure are not pivotally connected to the adjacent support arms outside the intermediate support structure. A long rectangular keyswitch structure includes a base plate, a keycap, and the above keycap lifting mechanism. In a keycap lifting mechanism, its keycap vertically covers part of an electrical connection structure of its switch circuit board.

### CROSS REFERENCE TO RELATED APPLICATIONS

This application claims the benefit of U.S. Provisional Application No. 63/696,374, filed on September 18th, 2024. The content of the application is incorporated herein by reference.

### BACKGROUND OF THE INVENTION

### 1. FIELD OF THE INVENTION

The present invention relates to a keyswitch structure, and more particularly to a long rectangular keyswitch structure and a keycap lifting mechanism thereof.

### 2. DESCRIPTION OF THE PRIOR ART

In a keyswitch structure, a keycap is supported by supports above a base plate and moves up and down relative to the base plate through the supports. The supports, the base plate, and their structural connection configuration all play an important role in whether the keycap can move stably. The keyswitch structure usually has a circuit board stacked on the base plate. However, the structure of the base plate that are connected to the supports, and an opening structure of the base plate that are provided to avoid structural interference with other components (such as the supports, the pivot joints between the supports, and the structure of the keycap that are connected to the supports) both will affect the disposition of the circuit board. As the size of the keyswitch structure decreases, it becomes increasingly difficult to maintain the movement stability of the keycap and supports. If the area provided by the base plate for placing the circuit board is also considered, the configuration design of the supports and related structures will become more difficult.

### SUMMARY OF THE INVENTION

In view of the problems in the prior art, an objective of the invention is to provide a keycap lifting mechanism, which uses a specially designed connection structure between supports to reduce the structural impact of the supports on the structure configuration of a base plate of a keyswitch structure and still maintain a certain degree of mechanical movement stability.

A keycap lifting mechanism of an embodiment according to the invention is used in a long rectangular keyswitch structure. The long rectangular keyswitch structure has a long side direction and a short side direction. The keycap lifting mechanism includes a first support and a second support. The first support includes a first long arm and a plurality of first support arms. The first long arm extends parallel to the long side direction. The first support arms protrude and extend from the first long arm non-parallel to the long side direction. The second support includes a second long arm and a plurality of second support arms. The second long arm extends parallel to the long side direction. The second support arms protrude and extend from the second long arm non-parallel to the long side direction. The first support and the second support are pivotally connected to each other around a pivot axis through the first support arms and the second support arms. The first support arms and the second support arms are staggered along the pivot axis. The pivot axis is parallel to the long side direction. Therein, the first support and the second support jointly form a first support structure, a second support structure, and an intermediate support structure along the pivot axis. The intermediate support structure is arranged between the first support structure and the second support structure. The intermediate support structure includes two of the first support arms and at least one of the second support arms located between the two first support arms. Two of the second support arms that are arranged outside the intermediate support structure and adjacent to the two first support arms of the intermediate support structure are not pivotally connected to the two first support arms of the intermediate support structure. Thereby, the number of pivotal connection structures between the first support and the second support is reduced, and the number of connections between the first support and the second support with a base plate of the long rectangular keyswitch structure is also reduced. Due to the special design of the connection structure between the first support and the second support, the keycap lifting mechanism can still maintain a certain degree of mechanical movement stability and reduce the impact on the structure configuration of the base plate of the long rectangular keyswitch structure, which is beneficial to the layout flexibility of components disposed on the base plate (e.g., a switch circuit board).

Another objective of the invention is to provide a long rectangular keyswitch structure, which includes the above keycap lifting mechanism. Thereby, the long rectangular keyswitch structure also uses the specially designed connection structure between supports to reduce the structural impact of the supports on the structure configuration of a base plate of the keyswitch structure and still maintain a certain degree of mechanical movement stability.

A long rectangular keyswitch structure of an embodiment according to the invention has a long side direction and a short side direction. The long rectangular keyswitch structure includes a base plate, a keycap, and a keycap lifting mechanism. The keycap is disposed above the base plate. The keycap lifting mechanism includes a first support and a second support. The first support includes a first long arm and a plurality of first support arms. The first long arm extends parallel to the long side direction. The first support arms protrude and extend from the first long arm non-parallel to the long side direction. The first support is connected to the keycap through the first long arm and is connected to the base plate through the first support arms. The second support includes a second long arm and a plurality of second support arms. The second long arm extends parallel to the long side direction. The second support arms protrude and extend from the second long arm non-parallel to the long side direction. The second support is connected to the keycap through the second long arm and is connected to the base plate through the second support arms. The first support and the second support are pivotally connected to each other around a pivot axis through the first support arms and the second support arms. The first support arms and the second support arms are staggered along the pivot axis. The pivot axis is parallel to the long side direction. The keycap is vertically movable up and down relative to the base plate through the first support and the second support. Therein, the first support and the second support jointly form a first support structure, a second support structure, and an intermediate support structure along the pivot axis. The intermediate support structure is arranged between the first support structure and the second support structure. The intermediate support structure includes two of the first support arms and at least one of the second support arms located between the two first support arms. Two of the second support arms that are arranged outside the intermediate support structure and adjacent to the two first support arms of the intermediate support structure are not pivotally connected to the two first support arms of the intermediate support structure. Thereby, the number of pivotal connection structures between the first support and the second support is reduced, and the number of connections between the first support and the second support with the base plate of the long rectangular keyswitch structure is also reduced. Due to the special design of the connection structure between the first support and the second support, the keycap lifting mechanism can still maintain a certain degree of mechanical movement stability and reduce the impact on the structure configuration of the base plate, which is beneficial to the layout flexibility of components disposed on the base plate (e.g., a switch circuit board).

Another objective of the invention is to provide a long rectangular keyswitch structure, in which an electrical connection structures of circuits on different layers of the switch circuit board is shifted outward until part of the electrical connection structure protrudes from a vertical projection of a keycap, thereby reducing the impact of the electrical connection structure on the layout of the switch circuit board below the keycap.

A long rectangular keyswitch structure of an embodiment according to the invention has a long side direction and a short side direction. The long rectangular keyswitch structure includes a base plate, a keycap, a first support, a second support, and a switch circuit board. The keycap is disposed above the base plate. The first support includes a first long arm and a plurality of first support arms. The first long arm extends parallel to the long side direction. The first support arms protrude and extending from the first long arm non-parallel to the long side direction. The first support is connected to the keycap through the first long arm and is connected to the base plate through the first support arms. The second support includes a second long arm and a plurality of second support arms. The second long arm extends parallel to the long side direction. The second support arms protrude and extend from the second long arm non-parallel to the long side direction. The second support is connected to the keycap through the second long arm and is connected to the base plate through the second support arms. The first support and the second support are pivotally connected to each other around a pivot axis through the first support arms and the second support arms. The first support arms and the second support arms are staggered along the pivot axis. The pivot axis is parallel to the long side direction. The keycap is vertically movable up and down relative to the base plate through the first support and the second support. The switch circuit board is stacked on the base plate. The switch circuit board includes a lower circuit carrier sheet and an upper circuit carrier sheet stacked above the lower circuit carrier sheet. A plurality of lower circuit traces are formed on the lower circuit carrier sheet, and a plurality of upper circuit traces are formed on the upper circuit carrier sheet. The lower circuit traces are electrically connected to the upper circuit traces through an electrical connection structure. A vertical projection of the keycap on the switch circuit board covers a portion of the electrical connection structure. Thereby, the electrical connection structure of the switch circuit board is no longer entirely located directly below the keycap, reducing the impact on the layout of the switch circuit board below the keycap (or increasing the layout flexibility of the switch circuit board below the keycap).

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a partially-exploded view of a long rectangular keyswitch structure according to an embodiment.

FIG. 2 is an exploded view of the long rectangular keyswitch structure in FIG. 1.

FIG. 3 is a top view of the long rectangular keyswitch structure in FIG. 1 with a keycap removed.

FIG. 4 is a top view of a first support and a second support of the long rectangular keyswitch structure in FIG. 1.

FIG. 5 is a top view of a switch circuit board and a base plate of the long rectangular keyswitch structure in FIG. 1.

FIG. 6 is a sectional view of the switch circuit board in FIG. 5 along the line X-X.

### DETAILED DESCRIPTION

Directional terms mentioned in the following embodiments, such as up, down, left, right, front or back, etc., are only for reference to the directions in the attached drawings. The prefixes of component names, such as first, second, ..., etc., are only used to distinguish components and facilitate description, and do not impose other restrictions on the components themselves; furthermore, components with the same prefix in various embodiments do not necessarily correspond. The correspondence of components in each embodiment should still depend on the specific structure described in each embodiment.

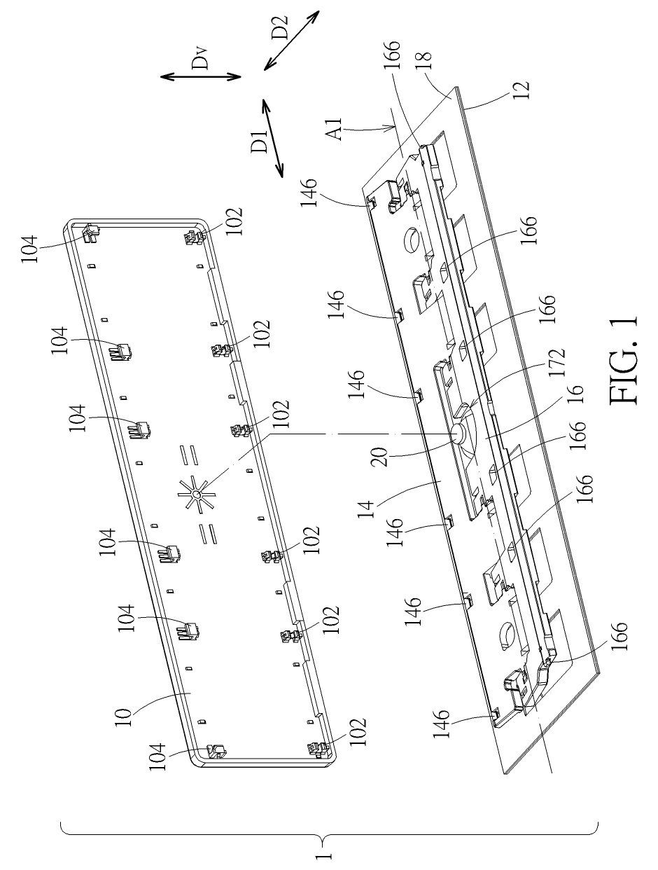

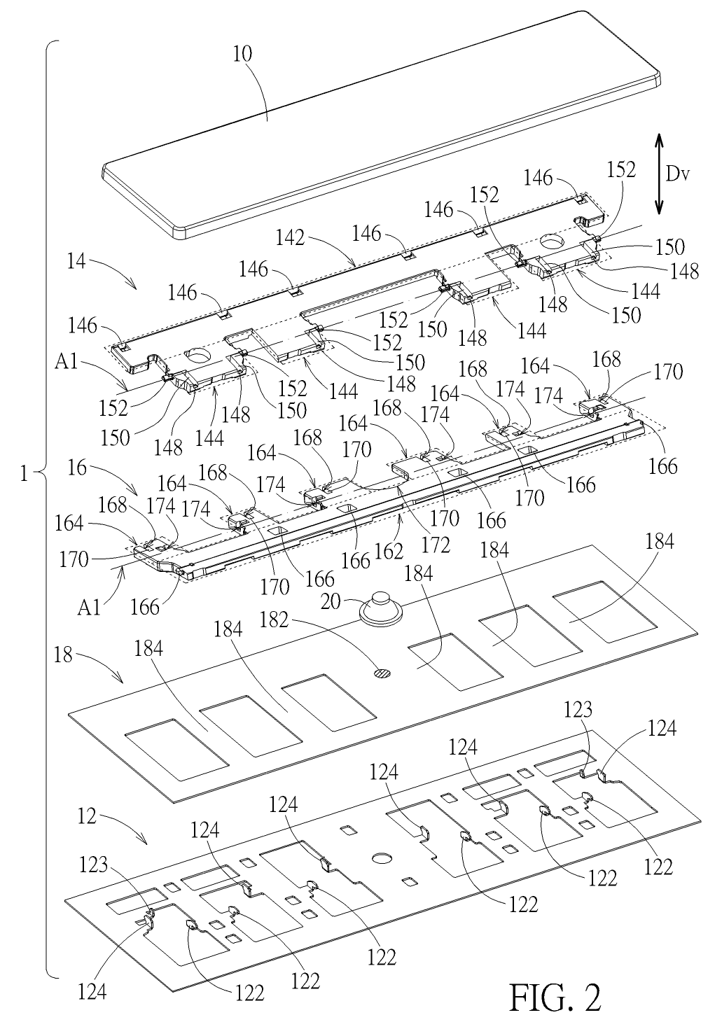

Please refer to FIG. 1 to FIG. 4. A long rectangular keyswitch structure 1 according to an embodiment has a long side direction D1 and a short side direction D2 (both indicated by double-headed arrows in the figures).The long side direction D1 is perpendicular to the short side direction D2. In practice, the long rectangular keyswitch structure 1 may be but not limited to Space key of a keyboard. The long rectangular keyswitch structure 1 includes a keycap 10, a base plate 12, a first support 14, a second support 16, a switch circuit board 18, and an elastic dome 20. The keycap 10 is disposed above the base plate 12. The first support 14 and the second support 16 are pivotally connected to each other around a pivot axis A1 (indicated by a chain line in the figures). The pivot axis A1 is parallel to the long side direction D1. The first support 14 and the second support 16 are connected to the keycap 10 and the base plate 12 to support the keycap 10 above the base plate 12, so that the keycap 10 can move relative to the base plate 12 (e.g., moving up and down or moving parallel to a vertical direction Dv) through the first support 14 and the second support 16; therein, the combination of the first support 14 and the second support 16 serves as a keycap lifting mechanism. The vertical direction Dv (indicated by a double-headed arrow in the figures) is perpendicular to the long side direction D1 and the short side direction D2. The switch circuit board 18 is stacked on the base plate 12 and has a switch 182 (indicated by a circle filled with oblique lines in FIG. 2), roughly corresponding to the center of the keycap 10. The elastic dome 20 is disposed on the switch circuit board 18 corresponding to the switch 182 and is located below the keycap 10. The keycap 10 can be pressed to move toward the base plate 12 so as to press the elastic dome 20 to trigger the switch 182.

Further, the first support 14 includes a first long arm 142 and a plurality of first support arms 144. The first long arm 142 extends parallel to the long side direction D1. The first support arms 144 protrude and extend from the first long arm 142 non-parallel to the long side direction D1 (e.g., extending perpendicular to the long side direction D1 in the embodiment). The extents of the first long arm 142 and the first support arms 144 are indicated by dashed-line frames in FIG. 2. The first support 14 is connected to the keycap 10 through the first long arm 142 and is connected to the base plate 12 through the first support arms 144; therein, a plurality of holder shafts 146 of the first long arm 142 are rotatably connected to a plurality of holder hooks 102 of the keycap 10, and a plurality of base shafts 148 of the first support arms 144 are rotatably and slidably connected to a plurality of base hooks 122 of the base plate 12. A base hole 150 is formed next to each base shaft 148. The base hook 122 extends into the corresponding base hole 150 to hook the corresponding base shaft 148.

The second support 16 includes a second long arm 162 and a plurality of second support arms 164. The second long arm 162 extends parallel to the long side direction D1. The second support arms 164 protrude and extend from the second long arm 162 non-parallel to the long side direction D1 (e.g., extending perpendicular to the long side direction D1 in the embodiment). The extents of the second long arm 162 and the second support arms 164 are indicated by dashed-line frames in FIG. 2. The second support 16 is connected to the keycap 10 through the second long arm 162 and is connected to the base plate 12 through the second support arms 164; therein, a plurality of sliding shafts 166 of the second long arm 162 are rotatably and slidably connected to a plurality of sliding hooks 104 of the keycap 10, and a plurality of base shafts 168 of the second support arms 164 are rotatably connected to a plurality of base hooks 124 of the base plate 12. A base hole 170 is formed next to each base shaft 168. The base hook 124 extends into the corresponding base hole 170 to hook the corresponding base shaft 168. Furthermore, the base plate 12 further includes a plurality of stop portions 123. The stop portions 123 limit the second support 16 so that the base shafts 168 remain hooked by the base hooks 124 correspondingly.

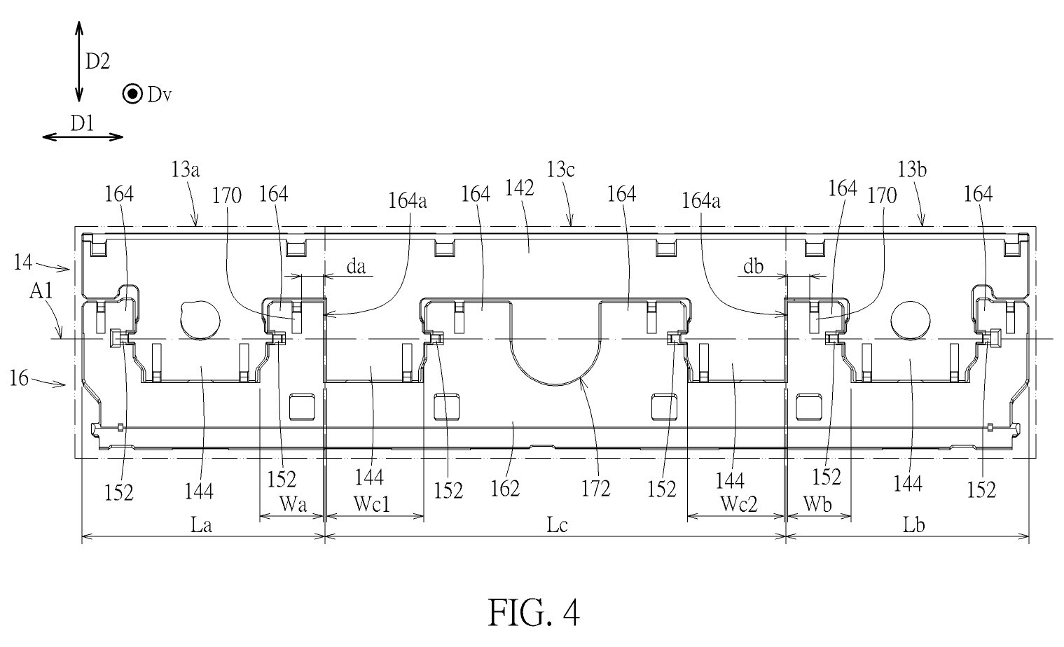

The first support 14 and the second support 16 are pivotally connected to each other around the pivot axis A1 through the first support arms 144 and the second support arms 164. The first support arms 144 and the second support arms 164 are staggered along the pivot axis A1. The first support 14 and the second support 16 jointly form a first support structure 13a, a second support structure 13b, and an intermediate support structure 13c (the extents of which are indicated by frames in chain lines in FIG. 4) along the pivot axis A1. The intermediate support structure 13c is arranged between the first support structure 13a and the second support structure 13b. The first support structure 13a includes two of the second support arms 164 and one of the first support arms 144 located between the two second support arms 164, in which both sides of the first support arm 144 are pivotally connected to the two second support arms 164 through two middle shafts 152 (in which the middle shafts 152 are inserted into corresponding pivot holes 174 on the second support arms 164). The second support structure 13b also includes two of the second support arms 164 and one of the first support arms 144 located between the two second support arms 164; similarly, in the second support structure 13b, both sides of the first support arm 144 are pivotally connected to the two second support arms 164 through two middle shafts 152 (in which the middle shafts 152 are inserted into corresponding pivot holes 174 on the second support arms 164). The intermediate support structure 13c includes two of the first support arms 144 and two of the second support arms 164 located between the two first support arms 144, in which a dome hole 172 (which accommodates an elastic dome 20, as shown in FIG. 1) is formed between the two second support arms 164. In the intermediate support structure 13c, each first support arm 144 is pivotally connected to the adjacent second support arm 164 through a middle shaft 152 (in which the middle shaft 152 is inserted into a corresponding pivot hole 174 on the adjacent second support arm 164). Overall, the intermediate support structure 13c also uses two middle shafts 152 for pivotal connection.

On the other hand, the first support structure 13a, the second support structure 13b, and the intermediate support structure 13c all use two holder shafts 146 and two sliding shafts 166 to be connected to the keycap 10, and use four base hooks 122 and 124 to be connected to the base plate 12 (in which the two base hooks 122 are connected to (the first support arms 144 of) the first support 14) and the two base hooks 124 are connected to (the second support arms 164 of) the second support 16). Moreover, two of the second support arms (i.e., in FIG. 4, the second support arm 164 on the right side of the first support structure 13a and the second support arm 164 on the left side of the second support structure 13b) that are arranged outside the intermediate support structure 13c and adjacent to the two first support arms 144 of the intermediate support structure 13c are not pivotally connected to the two first support arms 144 of the intermediate support structure 13c. Therefore, in an aspect, the first support structure 13a, the intermediate support structure 13c, and the second support structure 13b can be logically regarded as three independent support structures (except that they are adjacently connected through the first long arm 142 and the second long arm 162). Furthermore, the intermediate support structure 13c can also be logically regarded as two half-support structures (each half-support structure includes one first support arm 144 and one second support arm 164, which are pivotally connected by one middle shaft 152).

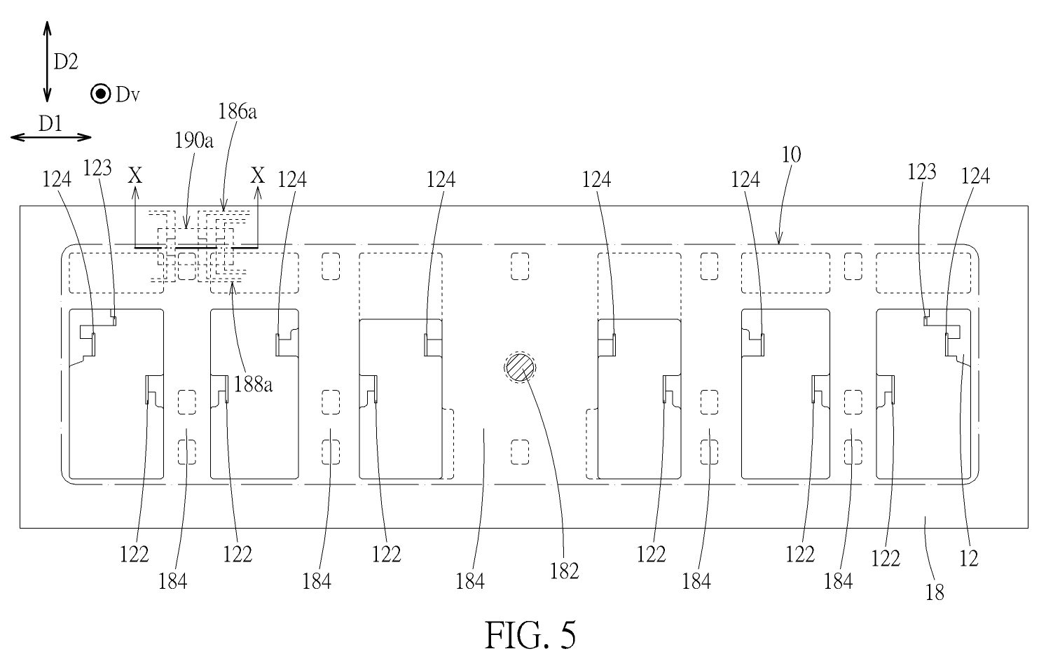

Please refer to FIG. 2 and FIG. 5; therein, in FIG. 5, the hidden outline of the base plate 12 is shown in dotted lines, and the outline of the vertical projection of the keycap 10 on the switch circuit board 18 is shown in chain lines. The base hooks 122 and 124 of the base plate 12 protrude upward. The switch circuit board 18 is stacked on the base plate 12 and has openings formed at locations corresponding to the base hooks 122 and 124 for the base hooks 122 and 124 to pass through. Hence, the configuration of the base hooks 122 and 124 affects the circuit layout within the switch circuit board 18. Generally, a long rectangular keyswitch structure uses an even number of support structures with the same structural logic, such as two or four, to obtain a balanced keycap supporting effect. However, using two support structures makes it difficult to provide uniform support for the keycap, affecting the stability of the keycap's vertical movement; using four (or more) support structures requires disposing a matching number of base hooks (e.g., sixteen base hooks), in which too many openings will be formed on the switch circuit board, seriously affecting the circuit layout within the switch circuit board (for example, the width of the circuit routing in the vertical direction (equivalent to the short side direction D2 in this embodiment) will become too narrow, significantly reducing the number of traces that can pass through). In the embodiment, the aspect ratio of keycap 10 is approximately 4:1. The first support structure 13a, the intermediate support structure 13c, and the second support structure 13b are arranged successively along the pivot axis A1 to effectively support the keycap 10 and provide a stable up-and-down movement mechanism for the keycap 10. The long rectangular keyswitch structure 1 uses a total of twelve base hooks 122 and 124. The switch circuit board 18 still retains five vertical circuit routing channel portions 184 (for circuit routing). Each circuit routing channel portion 184 retains a considerable width. Four of the circuit routing channel portions 184 (excluding the middle circuit routing channel portion 184) are located directly below the first support arms 144 in the vertical direction Dv and are not covered by the second support arms 164.

In addition, the base hooks 122 and 124 are generally formed by bending and extending from the base plate 12, so the configuration of the base hooks 122 and 124 will also affect the structural strength of the base plate 12. Generally, a long rectangular keyswitch structure uses an even number of support structures with the same structural logic, so it also uses more base hooks, which significantly reduces the structural strength of the base plate. In the embodiment, the long rectangular keyswitch structure 1 uses a total of twelve base hooks 122 and 124, thereby reducing the impact on the structural strength of the bottom plate 12, so that the base plate 12 can maintain a certain structural strength. Furthermore, the pivot structure (including the middle shaft 152 and the pivot hole 174) between the first support arm 144 and the second support arm 164 is generally thicker, and the base plate 12 also forms an opening to avoid the pivot structure. Please refer to FIG. 4 and FIG. 5. In the embodiment, the intermediate support structure 13c is not directly pivotally connected to the first support structure 13a and the second support structure 13b on both sides of the intermediate support structure 13c. Therefore, there is no need to form openings at these locations on the base plate 12, which can enhance the structural strength of the base plate 12.

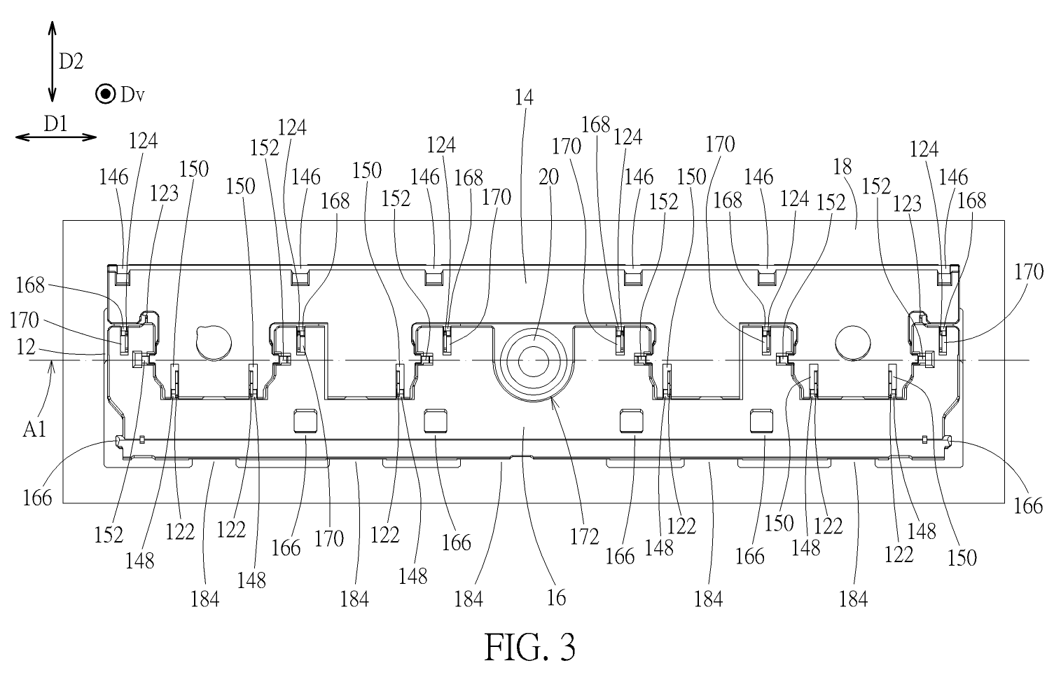

Please refer to FIG. 1 and FIG. 4 (therein, to simplify the figures, only some component symbols are shown. For other component symbols, please refer to FIG. 2 and FIG. 3). The intermediate support structures 13c are located on both sides of the elastic dome 20 (along the pivot axis A1). Therefore, overall, although the long rectangular keyswitch structure 1 does not use an even number of support structures, the keycap 10 can still be evenly supported (along the pivot axis A1). As shown by FIG. 4, a length Lc of the intermediate support structure 13c along the pivot axis A1 is greater than a length La of the first support structure 13a along the pivot axis A1, and is greater than a length Lb of the second support structure 13b along the pivot axis A1. Furthermore, lengths Wa and Wb of the two second support arms 164 (i.e., the second support arm 164 on the right side of the first support structure 13a and the second support arm 164 on the left side of the second support structure 13b) that are arranged outside the intermediate support structure 13c and adjacent to the two first support arms 144 of the intermediate support structure 13c along the pivot axis A1 are less than lengths Wc1 and Wc2 of the two first support arms 144 of the intermediate support structure 13c along the pivot axis A1. Thereby, although the length Lc of the intermediate support structure 13c is longer, the first support arm 144 thereof is wider (compared to the adjacent second support arms 164 of the first support structure 13a and the second support structure 13b), so that the overall structural strength of the intermediate support structure 13c can still be maintained.

In practice, in the second support arms 164 (i.e., the second support arm 164 on the right side of the first support structure 13a and the second support arm 164 on the left side of the second support structure 13b) adjacent to the first support arms 144 of the intermediate support structure 13c, a distance da (or a distance db) from the base hole 170 to a side surface 164a of the second support arm 164 toward the intermediate support structure 13c in a direction parallel to the pivot axis A1 can be designed to be 0.5 to 1.0 mm. This allows the width (i.e., the length Wc1 or Wc2) of the first support arm 144 (of the intermediate support structure 13c) to be increased while maintaining sufficient local structural strength of the second support arm 164 (for stable connection with the corresponding base hook 124), thereby enhancing the overall structural strength of the intermediate support structure 13c.

In addition, as shown by FIG. 4, in the intermediate support structure 13c, the two middle shafts 152 extend from the two first support arms 144 along the pivot axis A1 toward the inside of the intermediate support structure 13c (or extend toward each other). In the first support structure 13a, the two middle shafts 152 extend from the first support arm 144 along the pivot axis A1 toward the outside of the first support structure 13a (or extend away from each other). The extension direction of the middle shafts 152 of the second support structure 13b is also the same and will not be repeatedly described in addition. In the intermediate support structure 13c, the middle shafts 152 extend from the outer first support arms 144, while the corresponding pivot holes 174 are formed in the inner second support arms 164. This reduces the impact of the pivot structures (i.e., including the middle shafts 152 and the pivot holes 174) on the structural strength of the first support arms 144, that is, reducing the impact on the overall structural strength of the intermediate support structure 13c.

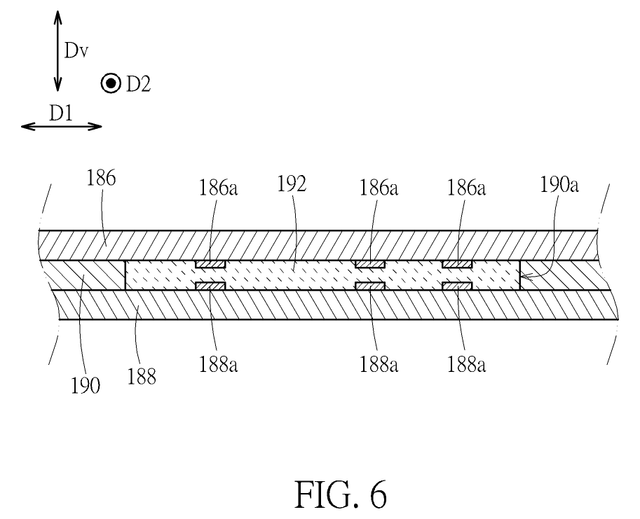

Please refer to FIG. 5 and FIG. 6. In the embodiment, the switch circuit board 18 is a layered structure (such as, but not limited to, a membrane circuit board, shown as a single board in FIG. 2 to simplify the figures), which includes an upper circuit carrier sheet 186, a lower circuit carrier sheet 188, and a space layer 190. The lower circuit carrier sheet 188 is stacked on base plate 12, the upper circuit carrier sheet 186 is stacked above the lower circuit carrier sheet 188, and the space layer 190 is sandwiched between the upper circuit carrier sheets 186 and the lower circuit carrier sheet 188. A plurality of upper circuit traces 186a (of which part of the hidden outlines are shown in dashed lines in FIG. 5) are formed on the upper circuit carrier sheet 186. A plurality of upper circuit traces 188a (of which part of the hidden outlines are shown in dashed lines in FIG. 5) are formed on the lower circuit carrier sheet 188. The space layer 190 separates the upper circuit traces 186a and the lower circuit traces 188a to prevent the upper circuit traces 186a and the lower circuit traces 188a from directly contacting each other. The space layer 190 has an opening 190a (of which the outline is shown in dashed lines in FIG. 5). The upper circuit traces 186a and the lower circuit traces 188a are electrically connected at the opening 190a through an electrical connection structure 192. Therein, the electrical connection structure 192 may be, but not limited to, an anisotropic conductive film (ACF) accommodated in the opening 190a. In FIG. 6, the shown portions of the upper circuit traces 186a and the lower circuit traces 188a correspond to the ends of the traces, serving as connection pads electrically connected through the ACF. In the embodiment, as shown by FIG. 5, a vertical projection of the keycap 10 on the switch circuit board 18 (the projection outline is shown in chain lines in FIG. 5) covers a portion of the electrical connection structure 192 (and the opening 190a); in other words, a portion of the electrical connection structure 192 (and the opening 190a) is not covered by the vertical projection of the keycap 10. On the other hand, the electrical connection structure 192 of circuits on different layers of the switch circuit board 18 is shifted outward until part of the electrical connection structure 192 protrudes from the vertical projection of the keycap 10, thereby reducing the impact of the electrical connection structure 192 on the layout of the switch circuit board 18 below the keycap 10 (or increasing the layout flexibility of the switch circuit board 18 below the keycap 10).

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A keycap lifting mechanism, used in a long rectangular keyswitch structure, the long rectangular keyswitch structure having a long side direction and a short side direction, the keycap lifting mechanism comprising:
a first support, the first support comprising a first long arm and a plurality of first support arms, the first long arm extending parallel to the long side direction, the first support arms protruding and extending from the first long arm non-parallel to the long side direction; and
a second support, the second support comprising a second long arm and a plurality of second support arms, the second long arm extending parallel to the long side direction, the second support arms protruding and extending from the second long arm non-parallel to the long side direction, the first support and the second support being pivotally connected to each other around a pivot axis through the first support arms and the second support arms, the first support arms and the second support arms being staggered along the pivot axis, the pivot axis being parallel to the long side direction;
wherein the first support and the second support jointly form a first support structure, a second support structure, and an intermediate support structure along the pivot axis, the intermediate support structure is arranged between the first support structure and the second support structure, and the intermediate support structure comprises two of the first support arms and at least one of the second support arms located between the two first support arms;
wherein two of the second support arms that are arranged outside the intermediate support structure and adjacent to the two first support arms of the intermediate support structure are not pivotally connected to the two first support arms of the intermediate support structure.

2. The keycap lifting mechanism according to claim 1, wherein the first support structure and the second support structure comprises the two second support arms that are arranged outside the intermediate support structure and adjacent to the two first support arms of the intermediate support structure, respectively.

3. The keycap lifting mechanism according to claim 2, wherein each of the two second support arms arranged outside the intermediate support structure and adjacent to the two first support arms of the intermediate support structure have a base shaft and a base hole formed next to the base shaft, and a distance from the base hole to a side surface of the second support arm facing the intermediate support structure in a direction parallel to the pivot axis is 0.5 to 1.0 mm.

4. The keycap lifting mechanism according to claim 1, wherein the first support structure comprises two of the second support arms and one of the first support arms located between the two second support arms.

5. The keycap lifting mechanism according to claim 4, wherein the first support structure comprises two middle shafts, the two second support arms of the first support structure and the first support arm of the first support structure are pivotally connected through the two middle shafts of the first support structure, the two middle shafts of the first support structure extend outward from the first support arm of the first support structure along the pivot axis, the intermediate support structure comprises two middle shafts, the two first support arms of the intermediate support structure and the at least one section support arm of the intermediate support structure are pivotally connected through the two middle shafts of the intermediate support structure, and the two middle shafts of the intermediate support structure extend inward from the two first support arms of the intermediate support structure along the pivot axis.

6. The keycap lifting mechanism according to claim 1, wherein a length of the intermediate support structure along the pivot axis is greater than a length of the first support structure along the pivot axis, and is greater than a length of the second support structure along the pivot axis.

7. The keycap lifting mechanism according to claim 1, wherein lengths of the two second support arms arranged outside the intermediate support structure and adjacent to the two first support arms of the intermediate support structure along the pivot axis are less than the lengths of the two first support arms of the intermediate support structure along the pivot axis.

8. The keycap lifting mechanism according to claim 1, wherein the intermediate support structure comprises two of the second support arms, and a dome hole is formed between the two second support arms.

9. The keycap lifting mechanism according to claim 1, wherein the first support arm has a base shaft, and the second support arm has a base shaft.

10. A long rectangular keyswitch structure, the long rectangular keyswitch structure having a long side direction and a short side direction, the long rectangular keyswitch structure comprising:
a base plate;
a keycap, the keycap being disposed above the base plate; and
a keycap lifting mechanism, the keycap lifting mechanism comprising:
a first support, the first support comprising a first long arm and a plurality of first support arms, the first long arm extending parallel to the long side direction, the first support arms protruding and extending from the first long arm non-parallel to the long side direction, the first support being connected to the keycap through the first long arm and being connected to the base plate through the first support arms; and
a second support, the second support comprising a second long arm and a plurality of second support arms, the second long arm extending parallel to the long side direction, the second support arms protruding and extending from the second long arm non-parallel to the long side direction, the second support being connected to the keycap through the second long arm and being connected to the base plate through the second support arms, the first support and the second support being pivotally connected to each other around a pivot axis through the first support arms and the second support arms, the first support arms and the second support arms being staggered along the pivot axis, the pivot axis being parallel to the long side direction, the keycap moving up and down relative to the base plate through the first support and the second support;
wherein the first support and the second support jointly form a first support structure, a second support structure, and an intermediate support structure along the pivot axis, the intermediate support structure is arranged between the first support structure and the second support structure, and the intermediate support structure comprises two of the first support arms and at least one of the second support arms located between the two first support arms;
wherein two of the second support arms that are arranged outside the intermediate support structure and adjacent to the two first support arms of the intermediate support structure are not pivotally connected to the two first support arms of the intermediate support structure.

11. The long rectangular keyswitch structure according to claim 10, further comprising a switch circuit board, wherein the switch circuit board is stacked on the base plate, the switch circuit board comprises a lower circuit carrier sheet and an upper circuit carrier sheet stacked above the lower circuit carrier sheet, a plurality of lower circuit traces are formed on the lower circuit carrier sheet, a plurality of upper circuit traces are formed on the upper circuit carrier sheet, the lower circuit traces are electrically connected to the upper circuit traces through an electrical connection structure, and a vertical projection of the keycap on the switch circuit board covers a portion of the electrical connection structure.

12. The long rectangular keyswitch structure according to claim 10, wherein the first support structure and the second support structure comprises the two second support arms that are arranged outside the intermediate support structure and adjacent to the two first support arms of the intermediate support structure, respectively.

13. The long rectangular keyswitch structure according to claim 12, wherein each of the two second support arms arranged outside the intermediate support structure and adjacent to the two first support arms of the intermediate support structure have a base shaft and a base hole formed next to the base shaft, each of the two second support arms is connected to the base plate through the base shaft, and a distance from the base hole to a side surface of the second support arm facing the intermediate support structure in a direction parallel to the pivot axis is 0.5 to 1.0 mm.

14. The long rectangular keyswitch structure according to claim 10, wherein the first support structure comprises two of the second support arms and one of the first support arms located between the two second support arms.

15. The long rectangular keyswitch structure according to claim 14, wherein the first support structure comprises two middle shafts, the two second support arms of the first support structure and the first support arm of the first support structure are pivotally connected through the two middle shafts of the first support structure, the two middle shafts of the first support structure extend outward from the first support arm of the first support structure along the pivot axis, the intermediate support structure comprises two middle shafts, the two first support arms of the intermediate support structure and the at least one section support arm of the intermediate support structure are pivotally connected through the two middle shafts of the intermediate support structure, and the two middle shafts of the intermediate support structure extend inward from the two first support arms of the intermediate support structure along the pivot axis.

16. The long rectangular keyswitch structure according to claim 10, wherein a length of the intermediate support structure along the pivot axis is greater than a length of the first support structure along the pivot axis, and is greater than a length of the second support structure along the pivot axis.

17. The long rectangular keyswitch structure according to claim 10, wherein lengths of the two second support arms arranged outside the intermediate support structure and adjacent to the two first support arms of the intermediate support structure along the pivot axis are less than the lengths of the two first support arms of the intermediate support structure along the pivot axis.

18. The long rectangular keyswitch structure according to claim 10, wherein the intermediate support structure comprises two of the second support arms, and a dome hole is formed between the two second support arms.

19. The long rectangular keyswitch structure according to claim 10, wherein the first support arm has a base shaft connected to the base plate, and the second support arm has a base shaft connected to the base plate.

20. A long rectangular keyswitch structure, the long rectangular keyswitch structure having a long side direction and a short side direction, the long rectangular keyswitch structure comprising:
a base plate;
a keycap, the keycap being disposed above the base plate;
a first support, the first support comprising a first long arm and a plurality of first support arms, the first long arm extending parallel to the long side direction, the first support arms protruding and extending from the first long arm non-parallel to the long side direction, the first support being connected to the keycap through the first long arm and being connected to the base plate through the first support arms;
a second support, the second support comprising a second long arm and a plurality of second support arms, the second long arm extending parallel to the long side direction, the second support arms protruding and extending from the second long arm non-parallel to the long side direction, the second support being connected to the keycap through the second long arm and being connected to the base plate through the second support arms, the first support and the second support being pivotally connected to each other around a pivot axis through the first support arms and the second support arms, the first support arms and the second support arms being staggered along the pivot axis, the pivot axis being parallel to the long side direction, the keycap moving up and down relative to the base plate through the first support and the second support; and
a switch circuit board, the switch circuit board being stacked on the base plate, the switch circuit board comprising a lower circuit carrier sheet and an upper circuit carrier sheet stacked above the lower circuit carrier sheet, a plurality of lower circuit traces being formed on the lower circuit carrier sheet, a plurality of upper circuit traces being formed on the upper circuit carrier sheet, the lower circuit traces being electrically connected to the upper circuit traces through an electrical connection structure, a vertical projection of the keycap on the switch circuit board covering a portion of the electrical connection structure.
